(19) United States
(12) Patent Application Publication
(10) Pub. No.: US 2003/0140091 A1
(43) Pub. Date: Jul. 24, 2003

(54) Telephone number capture from Web page

(75) Inventors: Maria Azua Himmel, Yorktown Heights, NY (US); Herman Rodriguez, Austin, TX (US); Newton James Smith JR., Austin, TX (US); Clifford Jay Spinac, Ausin, TX (US)

Correspondence Address: Jeffrey L. Streets, Suite 355, 13831 Northwest Freeway, Houston, TX, 77040, US

(73) Assignee: INTERNATIONAL BUSINESS MACHINES CORPORATION, ARMONK, NY

(21) Appl. No.: 10/047,837

(22) Filed: Jan. 16, 2002

(51) Int. Cl. G06F 15/16

(52) U.S. Cl. 709/203

(57) ABSTRACT

A method and system for capturing a telephone number record from a Web site. The method includes recording on the browser a destination address of a communications terminal that contains an electronic telephone directory, selecting one or more telephone number records to capture that are displayed on a Web page, and transmitting a message, either from the computer running the browser or from the server hosting the Web page sent to the communications terminal containing the electronic telephone directory. The telephone number record is then recorded in the electronic telephone directory.

### BACKGROUND OF THE INVENTION

1. Field of the Invention

The present invention relates to electronic telephone directories and more specifically, for automatically adding a telephone number to an electronic telephone directory.

2. Description of the Related Art

The Internet has provided businesses and consumers with a wealth of information in many forms including, for example, information on repairing appliances and purchasing automobiles, and the price and delivery of goods and services. Business enterprises have found the Internet to be quite profitable by allowing them to reach many customers around the world and therefore, most large companies and many small companies now have Web sites. While the effect of the proliferation of the Internet has been to decrease the amount of personal contact between a customer and a business, it has not totally replaced it. Customers and businesses still have the need to communicate directly and personally. For this reason, a Web site will often publish telephone numbers for customers to use to contact the business as necessary or as desired.

Because telephone companies often charge for providing telephone numbers from directory assistance, many people connect with a business enterprise's Web site to obtain a contact telephone number. Also, because large corporations may have many different telephone numbers for different locations and departments, the Web site may provide customers with the direct telephone number to the department or person they wish to contact without having to go through a series of separate telephone calls.

After obtaining a telephone number, many people want to store the telephone number in a telephone directory for future reference or for the convenience of dialing. Electronic telephone directories may be found in, for example, mobile telephones, personal computers, personal digital assistants (PDA's) and telephone networks. Usually telephone numbers stored in such devices can be searched for, selected, and then dialed automatically without having to dial the telephone number manually. For example, a mobile telephone often has a directory function for storing telephone numbers. Telephone numbers are usually added to the directory by using keystrokes on the mobile telephone's keypad. Alphanumeric references for the telephone number, for later identification and retrieval, also must be entered using the keys on the keypad. The mobile telephone can then scroll through the numbers or, by using alphanumeric keys, can search for and find a number assigned to a party and then automatically dial the selected stored telephone number. A personal computer can also retrieve a number from a telephone directory stored in the personal computer's memory and then automatically dial the selected number.

### SUMMARY OF THE INVENTION

The present invention provides a method for capturing a telephone number record from a Web site by a captor while the captor is surfing the Internet. The method includes recording on the captor's browser a destination address of a communications terminal containing an electronic telephone directory, selecting one or more telephone number records to capture that are displayed on a Web page, and receiving a message either from the computer running the browser or from the server hosting the Web page, sent to the communications terminal containing the electronic telephone directory. The telephone number record may comprise a telephone number and an alphanumeric identifier for the telephone number. Alternatively, the telephone number record may comprise of parameters selected from a telephone number, a contact name, an address, a FAX number, an e-mail address, a hyperlink to a Web site, a business name, a business specialty, business hours or combinations thereof The telephone number record may be downloaded to the Web site in a business card format or other acceptable format. The telephone number record is then recorded in the electronic telephone directory. The server may tailor the telephone number record it downloads to the Web page to provide information suitable for the address or geographical area to which the information is being transmitted.

The communications terminal may be any device that can store and retrieve information and is connectable to a telephone network, a device that can store and retrieve information and is connectable to a computer network, or combinations thereof. Examples may be a mobile telephone, a personal computer, a voice mail messaging service, a FAX machine, a handheld computer, a personal digital assistant, or combinations thereof. The address for the communications terminal could be, for example, a telephone number, an Internet address, or a computer network address.

The captor records the destination address for the intended communications terminal in the preferences on the browser so that the computer sending the message containing the telephone number record may read the address. Preferably, that computer is the computer running the browser. Alternatively, the computer could be the computer hosting the Web page. When the captor has found a telephone number record to capture, the captor selects the telephone number record by clicking on a Web page button, answering a query contained in a dialogue box, marking a box displayed on the Web page near the telephone record, or any other method supported by the server and browser software.

After the captor has selected the telephone number record, the computer, selected from either the computer running the browser or the server hosting the web page, generates a message that the computer will send to the address of the communications terminal. The computer records the destination address of the communications terminal from the browser. Before dispatching the message to the address of the communications terminal, the computer marks the message to identify the message as one containing a telephone number record. With the marking indicating that the message contains a telephone number record, the receiving communications terminal will process the message as instructed for an incoming telephone number record.

After receiving the message, the telephone number record is automatically recorded into the electronic telephone directory of the communications terminal. Alternatively, the electronic telephone directory may first search the existing telephone number records to determine if the directory already contains the telephone number record received in the message. Optionally, a password may have been included in the address of the communications terminal and marked on the message sent by the server. If the password marked on the message does not match the password for the communications terminal, the message may be discarded as an unauthorized message.

The present invention also provides a system for capturing and recording a telephone number record from a Web page into a communications terminal. This system comprises a server storing at least one telephone number record that may be displayed on a Web page, a computer having a browser capable of providing a destination address of a communications terminal having an electronic telephone directory, and a communications terminal having an electronic telephone directory, wherein a computer, selected from the computer running the browser or the server hosting the Web page, transmits a message to the electronic telephone directory at the destination address provided by the browser, the message containing the telephone number record, and the telephone number record was selected from the Web page.

The foregoing and other objects, features and advantages of the invention will be apparent from the following more particular description of a preferred embodiment of the inventions, as illustrated in the accompanying drawings wherein like reference numbers represent like parts of the invention.

### BRIEF DESCRIPTION OF THE DRAWINGS

FIG. 1 is a schematic diagram showing the system of the present invention.

FIG. 2 is a schematic diagram illustrating an example of a server system connected through a network.

FIG. 3 is a schematic diagram of a mobile telephone suitable for use with the present invention.

FIG. 4 is an example of a computer system suitable for use with the present invention.

FIG. 5 is a flow chart of a method for capturing a telephone number from a Web page.

FIG. 6 is a flow chart of a method for recording a captured telephone number in the telephone directory of a mobile telephone.

### DETAILED DESCRIPTION OF THE INVENTION

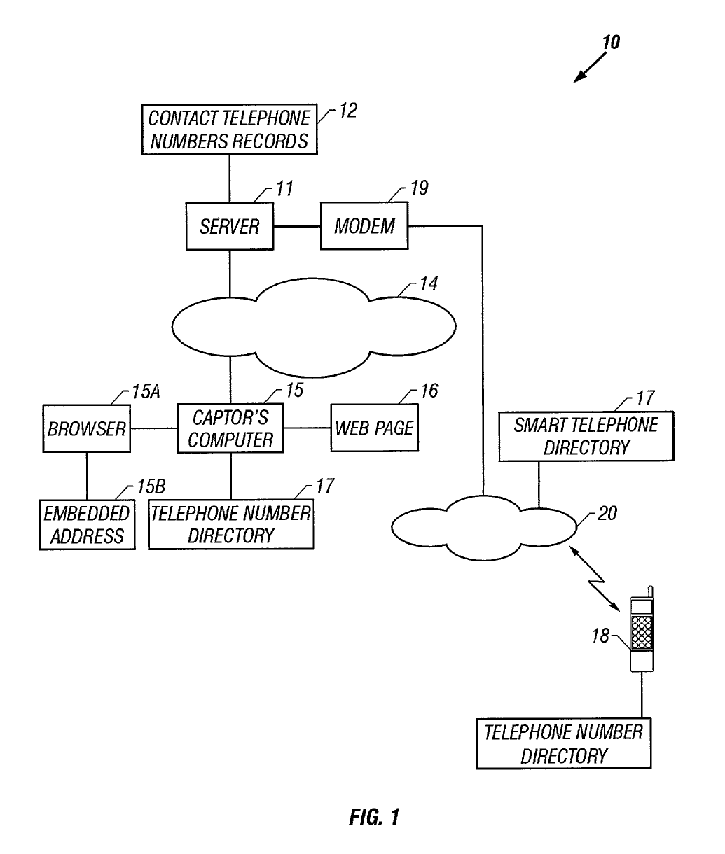

The present invention provides a method for capturing a telephone number record from a Web page, whereby the telephone number record is automatically recorded in an electronic telephone directory. FIG. 1 is a schematic diagram showing the telephone number record capturing system 10 of the present invention. A captor uses a computer 15 to access a server 11 through a computer system or network 14, such as the Internet, to view a Web page 16 delivered to the captor from the Web site of the server 11. While viewing the Web page, the captor uses a browser 15a to search the Web site for a desired contact telephone number record 12 that is displayed on the Web page 16. After selecting the contact telephone number record 12 and initializing the capture, the captor must provide an address for the destination electronic telephone directory 17, either by typing into a dialogue box or preferably, by having previously embedded the address into the preferences 15b of the browser 15a running on the captor's computer 15. Preferably, the captor's computer then sends the captured telephone number record 12 to the electronic telephone directory 17 located at the embedded destination address. Alternatively, the server 11 may send the captured contact telephone number record 12 to the electronic telephone directory 17 located at the embedded destination address. As shown in FIG. 1, the electronic telephone directory may be contained in or attached to a mobile telephone 18, a personal computer 15 or any smart telephone directory connected to a telephone network 20. The captor's computer 15 may be connected to a modem and the server 11 may also be connected to a LAN 21 for sending information to and receiving information from a telephone network 20.

The communications network 14 is the medium used to provide communications links between various devices and computers connected together within the telephone number capturing system 10. The communications network 14 may include permanent connections, such as wire or fiber optic cables, or temporary connections made through telephone or wireless communications. Captors 15 and servers 11 may be represented by a variety of computing devices, such as mainframes, personal computers, personal digital assistants (PDAs), smart phones, etc. The telephone number capturing system 10 may include additional servers, clients, routers and other devices not shown. In the depicted example, the telephone number capturing system 10 may utilize the Internet 14 with the telephone number capturing system 10 representing a worldwide collection of networks and gateways that use the TCP/IP suite of protocols to communicate with one another. Of course, the telephone number capturing system 10 may also utilize a number of different types of networks, such as, for example, an intranet, a local area network (LAN), a wide area network (WAN), or a wireless network.

The present invention may be implemented on a variety of hardware platforms and may be implemented in a variety of software environments. A typical operating system may be used to control program execution within the telephone number capturing system. Furthermore, although the preferred embodiment described below includes a “browser” 15a at the captor's computer 15 as the agent exchanging data in the security protocols with the Web Application Server, the agent does not have to be a conventional browser, e.g., Netscape Navigator® or Microsoft Internet Explorer®, but rather could be a mobile telephone or any program capable of processing the telephone number record request. In order to secure the information transmitted to and from the server, the captor may be capable of Public Key Infrastructure (PKI) technology exchanged in a security protocol such as the Secure Sockets Layer (SSL) version 3.0 and above.

The server 11 includes a conventional server software program, such as International Business Machines' Websphere®, for administering the content. The server and browser software include application programs that enable the server 11 to detect the embedded destination address 15B in the browser 15A, and to send a message to the electronic telephone directory 17 located at the embedded destination address.

FIG. 1 further illustrates captor 15 in communication with a server 11 to access and view the Web page 16 and contact telephone number records 12. As illustrated, the captor at a workstation 15 seeks access over a computer network 14 to the contact telephone number records 12 or other functions on the server 11 through the workstation's web browser 15A. The computer network 14 may be the Internet, an intranet, or other network. The content controller server 11 may be a Web Application Server (WAS), a server application, a servlet process, or the like. The server 11 may deliver a message to the electronic telephone directory 17 at the destination address 15B over the computer network 14 or through the telephone system 20 using a modem 19. The server 11 uses the telephone system 20 to deliver the message if the electronic telephone directory is part of a mobile telephone 18 or a smart telephone directory 17 connected to the telephone network.

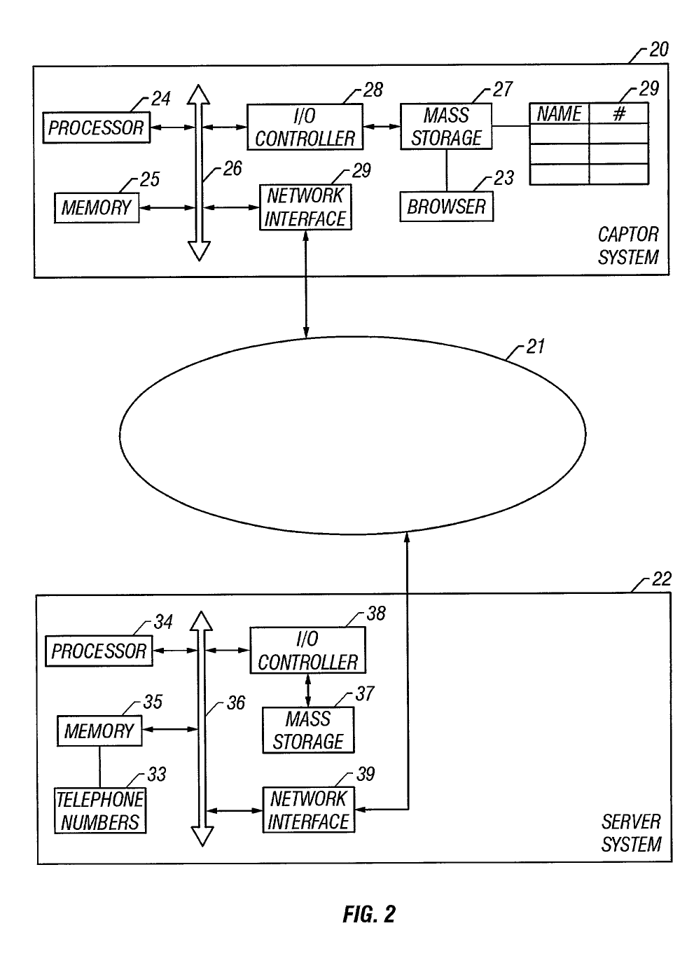

FIG. 2 depicts an example of a server system connected through the Internet. In this example, a server system 22 is connected through the Internet 21 to a captor's system 20. The captor's system 20 includes conventional components such as a processor 24, memory 25 (e.g. RAM), a bus 26, a mass storage device 27 (e.g. a magnetic hard disk or an optical storage disk) coupled to the bus 26 through an I/O controller 28, and a network interface 29, such as a conventional modem. The captor's system further includes a conventional browser 23 and a database 29 of telephone numbers and identifying names for each telephone number. The server system 22 also includes conventional components such as a processor 34, memory 35 (e.g. RAM), a bus 36, a mass storage device 37 (e.g. a magnetic or optical disk) coupled to the bus 36 through an I/O controller 38, and a network interface 39, such as a conventional modem.

It will be appreciated from the description below that the present invention may be implemented in software that is stored as executable instructions on a computer readable medium on the captor's system and the server system, such as mass storage devices 27 and 37 respectively, or in memories 25 and 35 respectively. These instructions would include, for example, an operating system program, application programs, and a browser program. The server system 22 is shown having a Web page and telephone number records 33 stored in memory 35. The captor's system 20 is thus suitable for processing: (1) displaying a Web page, (2) capturing a telephone number record from the Web page and (3) generating a message containing the captured telephone number record.

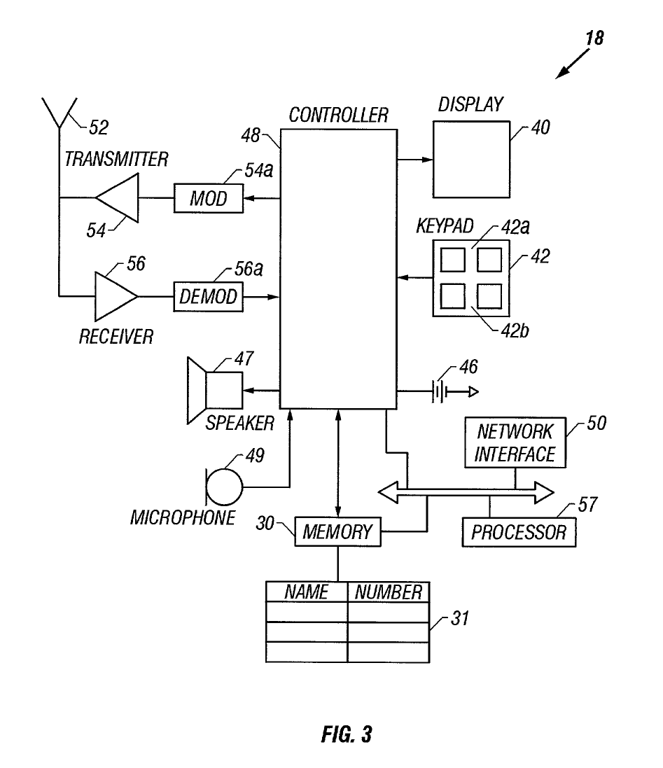

FIG. 3 depicts a typical mobile telephone used in the present invention. The mobile telephone 18 includes an antenna 52 for transmitting signals to and from the mobile network. The mobile telephone 18 includes a modulator 54A, a transmitter 54, a demodulator 56A, a receiver 56, and a controller 48 that provides signals to the transmitter and receives signals from the receiver. These signals include audio and/or computer readable files. Also connected to the controller 48 are a conventional speaker 47 and microphone 49, a display 40, and an input device, typically a keypad 42. The keypad includes keys 42a, which are numeric and alphanumeric keys typically found on a telephone, and other keys 42b, used for operating the mobile telephone including, but not limited to, a power key, a SEND key, and various menu scrolling and other keys. Also included are a processor 57 and a network interface 50, such as a conventional modem, and a battery power source 46.

The mobile telephone 18 also includes memory 30 that stores the values of various mobile system parameters and the number assignment module (NAM). It also stores telephone number records in a database 31 containing telephone numbers with their related alphanumeric identifiers. The database may be searched and a telephone number selected, and then automatically dialed by the mobile telephone system. The telephone operating system contains the programmed instructions to operate the telephone and the telephone's features, such as the electronic telephone directory and the directory's search and automatic dialing functions.

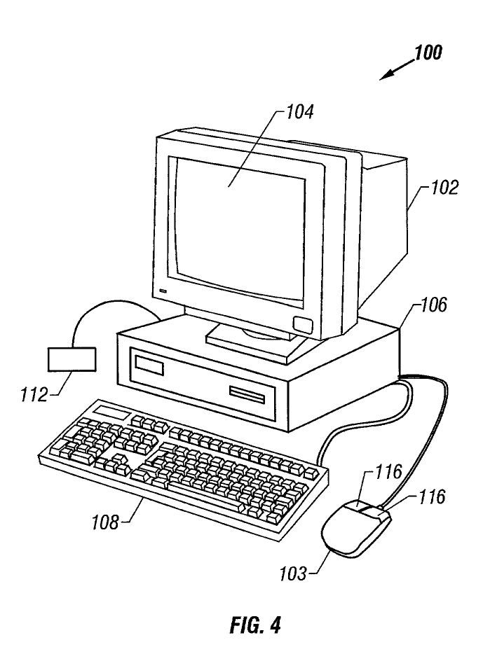

FIG. 4 shows captor's computer system 100 capable of running a browser or other document processor. The computer system 100 includes a display device 102 (such as a monitor), a display screen 104, a cabinet 106 (which encloses components typically found in a computer, such as CPU, RAM, ROM, video card, hard drive, sound card, serial ports, etc.), a keyboard 108, a mouse 103 and a modem 112. The mouse 103 may have one or more buttons, such as buttons 116. The computer requires some type of communication device such as modem 112 that allows computer system 100 to be connected to the Internet. Other possible communication devices include ethernet network cards.

The present invention provides a method for capturing a telephone number record from a Web site by a captor while the captor is browsing the Internet. If the captor is surfing the Internet, either looking for a contact telephone number for a particular person or business enterprise or for any other reason, the captor may find a telephone number that the captor wants to call. Instead of writing the number down, attempting to memorize it until the captor can place the call, or recording it in an electronic telephone directory by manually entering the telephone number by using keystrokes, the present invention provides a method for automatically capturing and recording the number into an electronic telephone directory. The method includes recording on the captor's browser a destination address for a communications terminal containing the electronic telephone directory, selecting one or more contact telephone number records to capture that are displayed on a Web page, and sending a message from the captor's computer to the communications terminal containing the electronic telephone directory. Alternatively, the message may be sent from the server hosting the Web page to the communications terminal containing the electronic telephone directory. The telephone number record is then recorded in the electronic telephone directory.

The communications terminal could be any device that can store and retrieve information and is connectable to a telephone network, a device that can store and retrieve information and is connectable to a computer network, or combinations thereof. Examples may be a mobile telephone, a personal computer, a voice mail messaging service, a FAX machine, a handheld computer, a personal digital assistant, or combinations thereof. The destination address for the communications terminal could be, for example, a telephone number, an Internet address, or a computer network address.

Preferably, the captor records the destination address for the communications terminal in the preferences of the browser so that the captor's computer may read the address. By using a menu function on the browser, the captor specifies the address on an interactive display provided by the browser. Alternatively, the captor could record different addresses for different communications terminals and then, when the captor selects the telephone number record to capture, indicate at that time to which communications terminal the captor's computer should send the telephone number record. Alternatively, the server could read the address from the browser and send the message containing the telephone number record.

The telephone number record that is captured may normally contain the telephone number and an alphanumeric identifier for the telephone number. Alternatively, the telephone number record may contain additional parameters such as an address associated with the telephone number, a FAX number, an e-mail address, a hyperlink to the Web site, a business name, a contact name and combinations thereof. Additionally, the telephone number record could contain business hours for a business, information on the business's specialty, advertising information and combinations thereof. While most electronic telephone directories may only contain a telephone number and an alphanumeric identifier, there are computer based electronic telephone directories that have fields for recording additional information such as those suggested above.

When the captor has found a telephone number record to capture, the captor selects the telephone number record by clicking on a Web page button, answering a query contained in a dialogue box, marking a box displayed on the Web page near the telephone record, or any other method supported by the server and browser software. The telephone number, names and any other additional information are recorded as a meta tag in the HTML of the Web page. Optionally, the server hosting the Web page could customize the information in the meta tag and display on the Web page telephone number record information tailored for the captor based on the geographical location of the address embedded in the browser. For example, if the server read the address embedded in the captor's browser and determined that the address was for a location in New York, then the meta tag could contain information for the New York location of the Web owner. Alternatively, if the server did not provide the information in a form that can be captured automatically, the captor may click a browser button, fill in the required telephone record information in a dialogue box displayed by the browser, and then proceed with the computer running the browser sending a message containing the telephone number record as recorded by the captor in the dialogue box.

Optionally, after selecting one telephone number record, the captor may select additional records to capture from the Web site hosted by the server. Additionally, the captor may edit the telephone number record by changing the alphanumeric identifier to better suit the filing system used by the captor in the electronic telephone directory. The captor may also edit the telephone number to be compatible with the captor's telephone system to include, for example, adding a country code, a “1” if the number will be long distance, or a “9” for reaching an outside line. Furthermore, if the telephone number record displayed on the Web page includes additional information, such as an e-mail address or business hours, the captor may edit that information to remove it or to make the information compatible with the format of the telephone number directory that will receive the information. Preferably, the displayed information will be in business card format or other standard format to minimize or alleviate the need to edit the information by the captor.

After the captor has selected the telephone number record, the captor's computer generates a message to send to the address of the communications terminal. If the captor's computer cannot find the address on the browser, then the captor's computer notifies the captor that the address is not available and the captor adds an address to the browser. The form of the address will notify the captor's computer whether to send the message over the Internet or over the telephone network. For example, if the address is a telephone number, the captor's computer will know to send the message over the telephone network. Alternatively, the server could record the address for the communications server from the browser, request the address from the captor if the address could not be found, and then generate the message to send to the address of the communications terminal. Optionally, if the resulting telephone call is long distance, the server may request a credit card number to charge the cost of the telephone call.

Before dispatching the message to the address of the communications terminal, the captor's computer marks the message to identify the message as one containing a telephone number record. Alternatively, if the address recorded on the browser also includes a password, the message may also be marked with the password. With the marking indicating that the message contains a telephone number record, the receiving communications terminal will process the message as instructed for an incoming telephone number record. Alternatively, if the message is marked with a password, and the password does not match the password of the communications terminal, then the communications terminal may discard the message or take other action as instructed for an incoming telephone number record with an incorrect or missing password. Alternatively, the server could mark the message and include the password if the server was being used to send the message containing the telephone number record.

When the communications terminal receives a message marked as one containing a telephone number record, the communications terminal notifies the captor that a telephone number record message has been received. The communications terminal may provide the notification by ringing the telephone as for a normal call, or may display a visual notification, or perform other such action as instructed and as is suitable for the type of communications terminal receiving the message.

After receiving the message, the telephone number record is automatically recorded into the electronic telephone directory of the communications terminal. Alternatively, the electronic telephone directory may first search the existing telephone number records to determine if the directory already contains the telephone number record received in the message. If there is no duplication, then the telephone number record is automatically recorded. If there is duplication, then the electronic telephone directory queries the captor whether to update the record or delete the telephone number record that was received in the message. The search for duplication determines if there is a duplicate telephone number or a duplicate alphanumeric identifier. Alternatively, if the telephone number record included additional data other than telephone number and alphanumeric identifier, the duplication search could be for each of the additional fields.

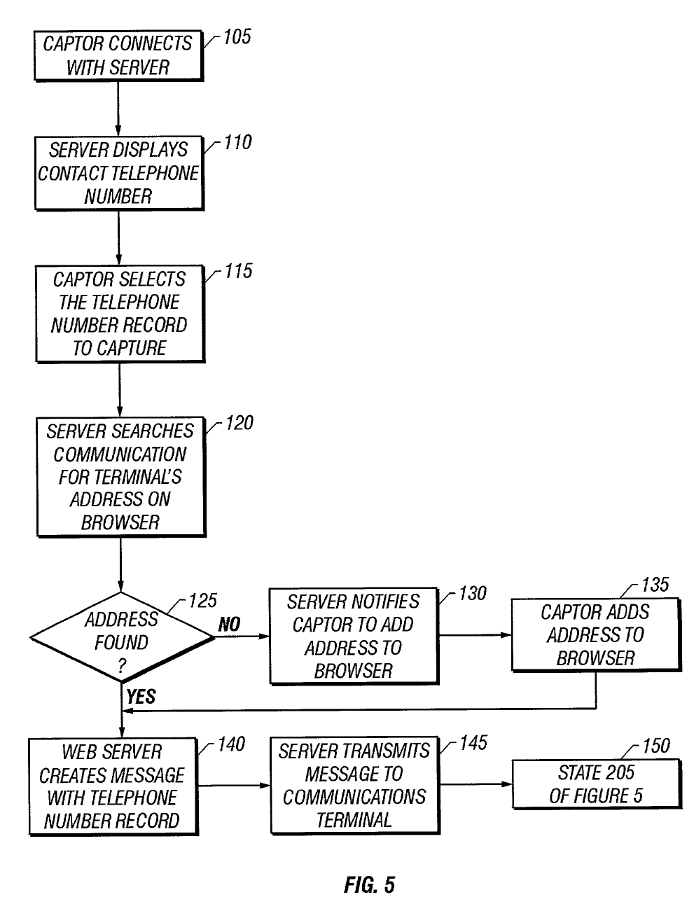

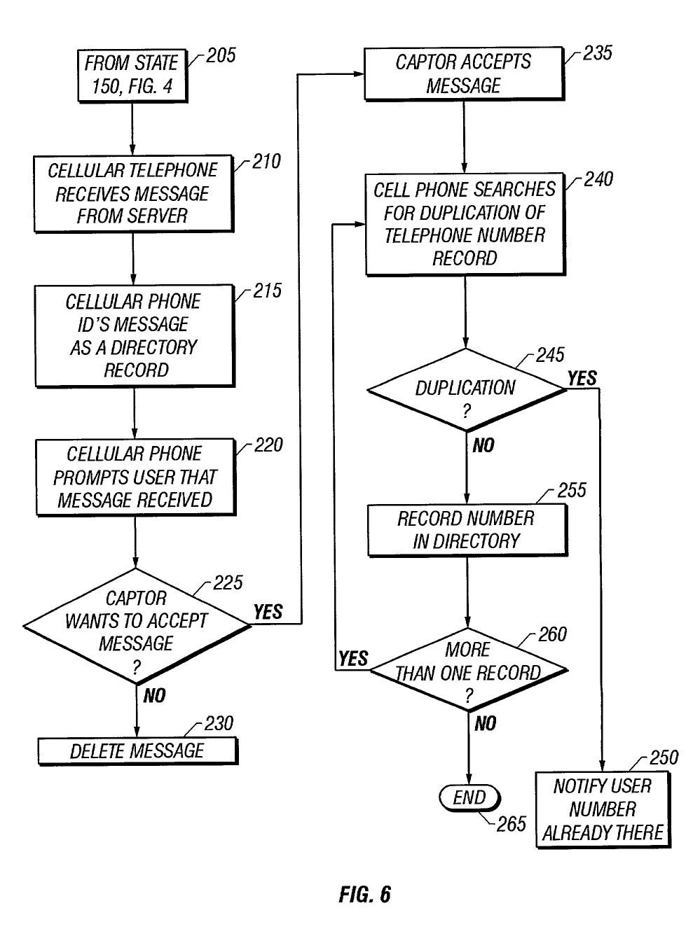

FIG. 5 is a flow chart of a method that may be executed on the system of FIG. 1. The method provides for the capture of a telephone number from the Internet. In state 105, the captor's computer 15 connects with the server 11. In state 110, the server downloads and the captor's computer displays the Web page containing the contact telephone number records 12 that the captor wants to record in the captor's electronic telephone directory 17. In state 115, the captor selects the telephone number to capture. The selection may be made by using a mouse to click on a button containing the telephone number on the Web page or by marking an “x” inside a box beside the telephone number displayed on the Web page or by other methods acceptable to the server software program. In state 120, the captor's computer searches the browser for an embedded destination address 15b to connect with the communications terminal containing the electronic telephone directory 17. The destination address may be, for example, a computer network address, an Internet address or a telephone number. If, in state 125, the captor's computer does find the embedded address, then, in state 140, the captor's computer 15 creates a message containing the selected telephone number record 12 to be added to the electronic telephone directory 17. In state 145, the server uses the embedded address to contact the electronic telephone directory 17 to deliver the message and, in state 150, the method continues to state 205 of FIG. 6. If, in state 125, the captor's computer 15 cannot find the address, then in state 130, the captor's computer 11 notifies the captor that the embedded address cannot be found and prompts the captor to enter an address or add the address to the browser 15a. In state 135, the captor provides the address 15B to the browser. Then, the method continues as in states 140 through 150 as discussed above.

The telephone number record is contained in a meta tag of the HTML. There are two options for providing this information. Preferably, the information is provided in a meta tag when the server hosting the Web page first downloads the Web page to the captor's computer. In this case, the Web page will display the information. Alternatively, the HTML may only contain instructions to display an icon, a button, or similar device on the Web page that may be clicked on by the captor using a mouse to generate a request for the host server to download a telephone number record for capture.

FIG. 6 is a flow chart of a method that may be executed on the system of FIG. 1 for recording a captured telephone number record in the telephone directory of a mobile phone. Alternatively, the electronic telephone directory does not have to be contained within a mobile telephone but could be contained within a personal computer, a voice mail messaging service, a FAX machine, a device that can store and retrieve information and is connectable to a telephone network, a device that can store and retrieve information and is connectable to an computer network, or combinations thereof. In state 205, the method continues from state 150 of FIG. 5. In state 210, the mobile telephone 18 receives the message from the captor's computer 15 using the telephone number embedded in the preferences 15a of the browser 15b. In state 215, the mobile telephone identifies the message as a telephone number record message being sent by the captor's computer. The message may be identified as being from the captor's computer if so marked by the captor's computer before it was sent. In state 220, the mobile telephone provides a prompt to the captor that a telephone directory message has been received. If, in state 225, the captor decides not to accept the record, then in state 230, the message is deleted. If, in state 225, the captor decides to accept the message, then in state 240, the electronic telephone directory 17 searches the directory to determine whether the telephone number is already recorded in the electronic telephone directory. If, in state 245, the telephone number has previously been recorded, then in state 250, the mobile telephone notifies the captor that the telephone number has previously been recorded so that appropriate action can be taken, such as instructing the electronic telephone directory to only update the fields that have changed. If, in state 245, the telephone number has not been previously recorded, then in state 255, the captured telephone number is recorded in the electronic telephone directory 17. If, in state 260, the message did not contain more than one captured telephone number record, then in state 265, the method ends. If, in state 260, there was more than one telephone number record, then the method continues to record the captured telephone number records from state 240 through state 265 as discussed above. Optionally, if the electronic telephone directory is formatted into directories or folders or other format for organizing electronic data, a separate folder may be created for downloading telephone number records sent by the captor's computer.

It will be understood from the foregoing description that various modifications and changes may be made in the preferred embodiment of the present invention without departing from its true spirit. It is intended that this description is for purposes of illustration only and should not be construed in a limiting sense. The scope of this invention should be limited only by the language of the following claims.

We claim:

1. A method for sending a telephone number record into a communications terminal comprising:
a. recording in a web browser a destination address of the communications terminal, the terminal having an automatic telephone directory;
b. selecting one or more telephone number records to capture from a Web page;
c. sending a message containing the one or more captured telephone number records from a computer to the destination address of the communications terminal, wherein the computer is selected from a computer running the web browser or a server hosting the Web page.

2. The method of claim 1, further comprising:
d. recording the one or more telephone number records into the electronic telephone directory.

3. The method of claim 1, further comprising:
d. searching the existing telephone number records in the electronic telephone directory;
e. determining if the telephone number record already exists in the electronic telephone directory;
f. recording the telephone number record if the telephone number and alphanumeric reference did not already exist in the electronic telephone directory.
g. providing notification to a communications terminal user if the telephone number or alphanumeric reference already exists in the electronic telephone directory.

4. The method of claim 3, wherein the step of providing notification further comprises:
h. prompting the communications terminal user for an instruction selected from instructions consisting of deleting the telephone number record in the message and updating the electronic telephone directory with the telephone number record,
i. executing the instruction.

5. The method of claim 1, wherein the communications terminal is selected from a mobile telephone, a personal computer, a voice mail messaging service, a FAX machine, a handheld computer, a personal digital assistant or combinations thereof.

6. The method of claim 1, wherein the communications terminal is selected from a device that can store and retrieve information and is connectable to a telephone network, a device that can store and retrieve information and is connectable to a computer network or combinations thereof.

7. The method of claim 1, wherein the destination address for the communications terminal is selected from a computer network address, an Internet address or a telephone number.

8. The method of claim 1, wherein the one or more telephone number records comprises a telephone number and an alphanumeric identifier for the telephone number.

9. The method of claim 1, wherein the telephone number record comprises parameters selected from a telephone number, a contact name, an address, a FAX number, an e-mail address, a hyperlink to a Web site, a business name, a business specialty, business hours or combinations thereof.

10. The method of claim 1, wherein the step of recording the destination address comprises:
a. selecting a menu function on the browser for recording the communications terminal's destination address;
b. specifying the destination address on an interactive display provided by the browser;
c. saving the destination address within the browser program.

11. The method of claim 1, wherein the step of selecting the telephone number record comprises:
a. searching the Web site for the telephone number record to capture;
b. viewing the Web page displaying the telephone number record to capture;
c. choosing the telephone number record to capture, wherein choosing is accomplished by means selected from clicking a mouse on a Web page button, marking a box displayed on the Web page near the telephone number record, answering a query contained in a dialogue box, other means compatible with the browser and server software, or combinations thereof.

12. The method of claim 11, further comprising
d. repeating steps a through c to select additional telephone number records.

13. The method of claim 11, wherein the telephone number record comprises a telephone number and an alphanumeric identifier for the telephone number, the method further comprising:
d. editing the alphanumeric portion of the chosen telephone number record, wherein the editing better identifies the telephone number;
e. editing the telephone number portion of the chosen telephone number record, wherein the editing makes the telephone number compatible with the communication terminal's telephone system.

14. The method of claim 11, wherein the telephone number record is displayed in a standard format suitable for a format of the electronic telephone directory.

15. The method of claim 1, wherein the step of selecting the telephone number record comprises:
d. searching the Web site for the telephone number record to capture;
e. viewing the Web page displaying the telephone number record to capture;
f. choosing the telephone number record to capture, wherein choosing is accomplished by instructing the browser to display a telephone number record dialogue box, and copying information from the Web page into the dialogue box by the captor.

16. The method of claim 1, further comprising:
detecting the destination address of the communications terminal on the browser;
determining from the destination address the means for dispatching the message, wherein the means is selected from dispatching over a computer network or a telephone network;
composing a message containing the captured telephone number record;
marking the message to indicate that the message is a telephone directory record;
dispatching the message to the destination address.

17. The method of claim 16, wherein the computer is the server hosting the Web page, further comprising requesting a credit card number by the server, wherein the cost of a long distance telephone call to dispatch the message may be charged.

18. The method of claim 16, further comprising:
detecting a password for the communications terminal on the browser, wherein the password is recorded on the browser with the destination address of the communications terminal;
retrieving the password by the computer;
marking the message with the password.

19. The method of claim 1, wherein by the communications terminal, the method further comprises:
determining that the message contains a telephone directory record,
discarding the message if the message is not marked with the password.

20. The method of claim 1, wherein by the communications terminal, the method further comprises:
determining that the message contains a telephone directory record,
providing notification that the message has arrived at the destination address.

21. A system for sending a telephone number record into a communications terminal comprising:
a server storing at least one telephone number record that may be displayed on a Web page,
a computer having a browser capable of providing a destination address of a communications terminal having an electronic telephone directory,
a communications terminal having an electronic telephone directory, wherein a transmitter sends a message to the electronic telephone directory at the destination address provided by the browser, wherein the message contains the telephone number record, wherein the telephone number record was selected from the Web page, and wherein the transmitter is selected from the computer or the server.

22. The system of claim 21, wherein the communications terminal is selected from a mobile telephone, a personal computer, a voice mail messaging service, a FAX machine, a handheld computer, a personal digital assistant or combinations thereof.

23. The system of claim 21, wherein the communications terminal is selected from a device that can store and retrieve information and is connectable to a telephone network, a device that can store and retrieve information and is connectable to a computer network, or combinations thereof.

24. The system of claim 21, wherein the destination address for the communications terminal is selected from a computer network address, an Internet address or a telephone number.

25. The system of claim 21, wherein the telephone number record comprises a telephone number and an alphanumeric identifier for the telephone number.

26. The system of claim 21, wherein the telephone number record comprises parameters selected from a telephone number, a contact name, an address, a FAX number, an e-mail address, a hyperlink to a Web site, a business name or combinations thereof.

27. A computer program product including instructions embodied on a computer readable medium, the instructions comprising:
d. recording instructions for recording in a web browser a destination address of the communications terminal, the terminal having an automatic telephone directory;
e. selecting instructions for selecting one or more telephone number records to capture from a Web page;
f. sending instructions for sending a message from a computer to the destination address of the communications terminal, wherein the message contains the one or more captured telephone number records and wherein the computer is selected from a computer running the web browser or a server hosting the Web page.

28. The computer program product of claim 27, further comprising:
e. recording instructions for recording the one or more telephone number records into the electronic telephone directory.

29. The computer program product of claim 27, further comprising:
d. searching instructions for searching the existing telephone number records in the electronic telephone directory;
e. determining instructions for determining if the telephone number record already exists in the electronic telephone directory;
f. recording instructions for recording the telephone number record if the telephone number and alphanumeric reference did not already exist in the electronic telephone directory,
g. providing instructions for providing notification to a communications terminal user if the telephone number or alphanumeric reference already exists in the electronic telephone directory.

30. The computer program product of claim 27, wherein the step of providing notification further comprises:
h. prompting instructions for prompting the communications terminal user for a command selected from commands consisting of deleting the telephone number record in the message and updating the electronic telephone directory with the telephone number record,
i. executing instructions for executing the command.

31. The computer program product of claim 27, wherein the communications terminal is selected from a mobile telephone, a personal computer, a voice mail messaging service, a FAX machine, a handheld computer, a personal digital assistant or combinations thereof.

32. The computer program product of claim 27, wherein the communications terminal is selected from a device that can store and retrieve information and is connectable to a telephone network, a device that can store and retrieve information and is connectable to a computer network or combinations thereof.

33. The computer program product of claim 27, wherein the destination address for the communications terminal is selected from a computer network address, an Internet address or a telephone number.

34. The computer program product of claim 27, wherein the telephone number record comprises a telephone number and an alphanumeric identifier for the telephone number.

35. The computer program product of claim 27, wherein the telephone number record comprises parameters selected from a telephone number, a contact name, an address, a FAX number, an e-mail address, a hyperlink to a Web site, a business name or combinations thereof.

36. The computer program product of claim 27, further comprising:
detecting instructions for detecting the destination address of the communications terminal on the browser;
determining instructions for determining from the destination address the means for dispatching the message, wherein the means is selected from dispatching over a computer network or a telephone network;
composing instructions for composing a message containing the captured telephone number record;
marking instructions for marking the message to indicate that the message is a telephone directory record;
dispatching instructions for dispatching the message to the destination address.

37. A method for sending a telephone number record for storage in a communications terminal comprising:
detecting on a browser a destination address of the communications terminal, the communications terminal having an automatic telephone directory,
downloading a Web page containing a telephone number record tailored for the geographical location of the destination address,
receiving a request to send one or more telephone number records, wherein the telephone number records are displayed by the browser on the Web page
sending a message from a server hosting the Web page to the destination address of the communications terminal, wherein the message contains the one or more captured telephone number records.

38. The method of claim 37, further comprising:
recording the one or more telephone number records into the electronic telephone directory.

39. The method of claim 37, wherein the detecting a destination address is selected from reading the destination address embedded in a browser or requesting the destination address.
